(19) United States
(12) Patent Application Publication
(10) Pub. No.: US 2017/0357705 A1
(43) Pub. Date: Dec. 14, 2017

(54) PERFORMING A SYNCHRONIZATION OPERATION ON AN ELECTRONIC DEVICE

(71) Applicant: KnuEdge Incorporated, San Diego, CA (US)

(72) Inventors: Mario Mendez Lojo, Austin, TX (US); Andrew White, Austin, TX (US)

(21) Appl. No.: 15/177,068

(22) Filed: Jun. 8, 2016

(51) Int. Cl. G06F 17/30; G06F 1/32

(52) U.S. Cl. CPC G06F 17/30581; G06F 1/3296

(57) ABSTRACT

In an illustrative example, a method of operation of an electronic device includes identifying a plurality of threads. Each thread of the plurality of threads is configured to execute a plurality of instructions including a barrier instruction corresponding to a target of a synchronization operation. The method further includes selecting a master thread to perform one or more operations associated with the synchronization operation. The method also includes providing an indication of a number of threads included in the plurality of threads to the master thread.

### FIELD

This disclosure is generally related to electronic devices and more particularly to processors of electronic devices that perform synchronization operations.

### BACKGROUND

Electronic devices include computers and other devices that store data, retrieve data, process data, and perform other operations. Electronic devices may include one or more processors that execute instructions to perform such operations.

In a multithreaded implementation, a processor may execute multiple threads of instructions (e.g., applications or programs) to increase processing speed, processing capability, or both. For example, a thread of execution may correspond to a particular program or an application executed by the processor. Depending on the particular implementation, the processor may execute multiple threads sequentially or in parallel.

In some cases, a synchronization operation may be performed to “synch up” threads of a processor. Synchronization operations utilize processor resources. For example, in some devices, threads of a processor may halt execution to wait for another thread of the processor to participate in a synchronization operation. Halting execution of the threads may slow operation of the processor, reducing performance of an electronic device.

### SUMMARY

In an illustrative example, an electronic device performs an initialization operation to identify threads that are associated with a particular target (also referred to herein as an object) of a synchronization operation. In some implementations, the initialization operation may be performed to identify threads of the synchronization operation prior to executing the threads. For example, the electronic device may parse instructions of the threads to identify that a positive integer number of threads (e.g., N threads) are to perform the synchronization operation, such as by detecting a particular instruction (e.g., a barrier instruction) that indicates the target of the synchronization operation. The synchronization operation may include synchronizing data among the N threads, synchronizing a joint process performed by the N threads, or both, as illustrative examples.

A “master” thread (also referred to herein as a “root” thread) may control or supervise one or more aspects of the synchronization operation. For example, upon execution of a barrier instruction, each of the N threads may provide a message to the master thread indicating that the thread is ready to perform the synchronization operation. Upon receiving messages from each of the N threads, the master thread may initiate the synchronization operation, such as by setting a flag of a register. The threads may detect the flag and may perform the synchronization operation (e.g., by synchronizing data, by synchronizing a joint process, or both, as illustrative examples).

Use of an initialization operation may improve performance of the electronic device. For example, in some cases, selectively identifying threads using the initialization operation may enable the processor to avoid a “global” synchronization operation that globally blocks all thread execution. In an illustrative example, use of the initialization operation enables the electronic device to identify a subset of threads of the electronic device that are associated with a synchronization operation. For example, N may correspond to a subset of threads executed by the electronic device, where the electronic device executes N+1 or more threads. In this case, N threads may be halted in connection with the synchronization operation (instead of halting N+1 or more threads). In other examples, the N threads may include each thread of the electronic device. Other illustrative aspects, examples, and advantages of the disclosure are described further below with reference to the drawings.

### BRIEF DESCRIPTION OF THE DRAWINGS

FIG. 1 is a block diagram of an illustrative example of an electronic device that includes a processor configured to perform an initialization operation to identify a subset of threads of the electronic device that are associated with a synchronization operation.

FIG. 2 is a diagram of an illustrative example of a synchronization operation, such as a synchronization operation performed by the electronic device of FIG. 1.

FIG. 3 is a flow chart of an illustrative example of an initialization operation that may be performed at an electronic device, such as the electronic device of FIG. 1.

FIG. 4 is a flow chart of an illustrative example of a synchronization operation that may be performed at an electronic device, such as the electronic device of FIG. 1.

### DETAILED DESCRIPTION

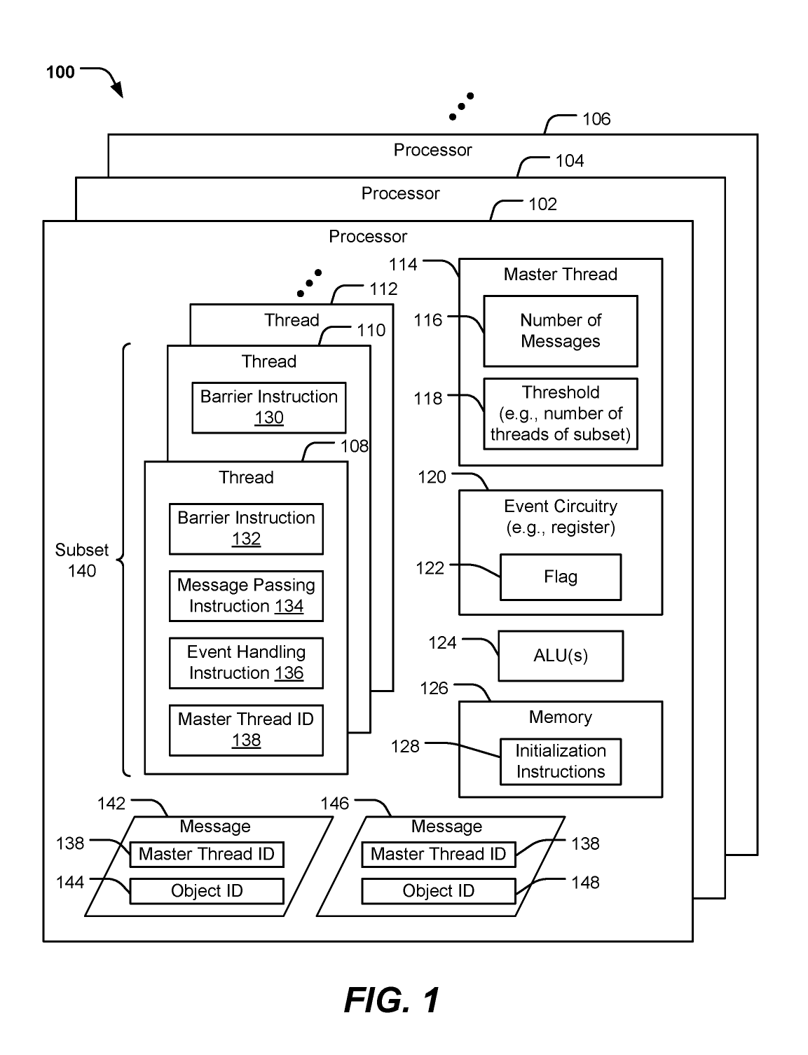

FIG. 1 depicts an illustrative example of an electronic device 100. The electronic device 100 includes one or more processors, such as a processor 102. FIG. 1 also depicts that the electronic device 100 may include one or more additional processors (e.g., a processor 104 and a processor 106). Although FIG. 1 illustrates three processors, in other examples, the electronic device 100 may include a different number of processors.

The processors 102, 104, and 106 may be included in one or more integrated circuits. To illustrate, in some examples, the processors 102, 104, and 106 are included in a common integrated circuit. In other examples, the processors 102, 104, and 106 are included in multiple integrated circuits. For example, the processor 102 may be included in a first integrated circuit, the processor 104 may be included in a second integrated circuit, and the processor 106 may be included in the first integrated circuit, the second integrated circuit, or a third integrated circuit. Examples of integrated circuits include system-on-chip (SoC) devices, graphics processing units (GPUs), and central processing units (CPUs), as illustrative examples.

The processors 102, 104, 106 may be configured to execute one or more threads of instructions (e.g., applications). To illustrate, the example of FIG. 1 depicts that the processor 102 may execute a first thread 108, a second thread 110, and a third thread 112. One or more threads of a processor of the electronic device 100 may function as a “master” thread (also referred to herein as a “root” thread). For example, FIG. 1 illustrates that the processor 102 may execute a master thread 114. Depending on the particular implementation, the processor 102 may execute the threads 108, 110, 112, and 114 sequentially (e.g., by assigning execution of the threads 108, 110, 112, and 114 to particular clock cycles of the processor 102), in parallel, or a combination thereof.

The processor 102 may include event circuitry 120, and the event circuitry 120 may include one or more registers. The event circuitry 120 may be configured to store one or more values, such as a flag 122. The event circuitry 120 may include a register configured to store the flag 122, as an illustrative example.

The processor 102 includes one or more processing units, such as an arithmetic logic unit (ALU) 124, or a floating point unit (FPU). The processor 102 may include or may be coupled to a memory 126. To illustrate, the memory 126 may include one or more of a cache, a buffer, a volatile memory, a non-volatile memory, a main memory, or another memory device.

During operation, the electronic device 100 may perform an initialization operation. The initialization operation may be performed at one or more of the processors 102, 104, and 106. The initialization operation may be performed using initialization instructions 128. The initialization operation may be performed in response to power-up of the electronic device 100, in response to loading one or more applications corresponding to one or more of the threads 108, 110, 112, and 114 (e.g., from a memory of the electronic device 100), prior to executing one or more of the threads 108, 110, 112, and 114, during execution of one or more of the threads 108, 110, 112, and 114, in response to another condition, or a combination thereof.

To illustrate, the processor 102 may execute the initialization instructions 128 to identify threads of the electronic device 100 that are associated with a particular object. As used herein, an “object” may refer to a target of a synchronization operation (e.g., a synchronization operation that synchronizes data, a synchronization operation that synchronizes processes, or both). To illustrate, the first thread 108 may include a barrier instruction 132, and the second thread 110 may include a barrier instruction 130. The barrier instructions 130, 132 may indicate a particular object (or target), such as data to be synchronized between the threads 108, 110, processes to be synchronized between the threads 108, 110, or both. For example, an operand of the barrier instructions 130, 132 may indicate the particular object. The processor 102 may execute the initialization instructions 128 to identify that the threads 108, 110 are associated with a common object (e.g., by identifying the barrier instructions 130, 132). In an illustrative example, the processor 102 executes the initialization instructions 128 to parse instructions of the threads 108, 110, 112, and 114 to identify which of the threads 108, 110, 112, and 114 are to perform a particular synchronization operation, such as by detecting the barrier instructions 130, 132.

To further illustrate, in the example of FIG. 1, the processor 102 may identify a subset 140 of threads of the electronic device 100 that are associated with a synchronization operation. In this case, the third thread 112 is not associated with the synchronization operation (e.g., may not include a barrier instruction that indicates an object identified by the barrier instructions 130, 132), and the processor 102 excludes the third thread 112 from the subset 140.

The subset 140 may include a first number of threads that is less than a second number of threads (e.g., a total number of threads) of the electronic device 100. For example, the first number may correspond to N (where N is a positive integer number), and the second number is greater than N.

The processor 102 may execute the initialization instructions 128 to select a master thread associated with the synchronization operation. To illustrate, the processor 102 may select the master thread 114 to control or supervise one or more aspects of the synchronization operation. In other examples, the processor 102 may select another thread as the master thread, such as one of the threads 108, 110, and 112.

The processor 102 may select a master thread (e.g., the master thread 114) using one or more techniques. In an illustrative example, the processor 102 is configured to select, from among threads associated with the synchronization operation, the thread associated with the lowest thread identifier (or thread index value). To illustrate, if the master thread 114 is associated with a thread identifier of zero, if the first thread 108 is associated with a thread identifier of one, and if the second thread 110 is associated with a thread identifier of two, then the processor 102 may select the thread 114 as the master thread. Alternatively or in addition, the processor 102 may use another technique to select a master thread. For example, the processor 102 may randomly or pseudo-randomly select a master thread, may use a round robin technique to select a master thread, or may use another technique to select a master thread.

In some examples, the master thread 114 may be included in the subset 140. For example, if the master thread 114 includes a barrier instruction that indicates an object identified by the barrier instructions 130, 132, then the master thread 114 may be included in the subset 140. In other cases, the master thread 114 is not included in the subset 140.

The processor 102 may execute the initialization instructions 128 to provide an indication of the master thread 114 to each thread of the subset 140, such as by providing a master thread identifier 138 to each thread of the subset 140. For example, the processor 102 may provide the master thread identifier 138 (e.g., a thread index value) to each thread of the subset 140 to indicate that the master thread 114 is to control or supervise one or more aspects of the synchronization operation. In some examples, the master thread identifier 138 may indicate a particular processor that includes the master thread 114, a particular integrated circuit that includes the master thread 114, or a combination thereof.

The processor 102 may execute the initialization instructions 128 to determine a number of threads (also referred to herein as cardinality) associated with a synchronization operation. The processor 102 may provide an indication of the number of threads associated with the synchronization operation to the master thread 114. For example, if the subset 140 includes N threads, the processor 102 may provide an indication of N threads to the master thread 114.

After performing the initialization operation to initialize a synchronization operation, the processor 102 may perform the synchronization operation to synchronize a target (e.g., data and/or processes) associated with at least a subset of threads of the electronic device 100. In the example of FIG. 1, the processor 102 may perform the synchronization operation to synchronize a target associated with threads of the subset 140.

To illustrate, upon executing the barrier instruction 132, the processor 102 may halt execution of the first thread 108 until synchronization of a target indicated by the barrier instruction 132 is performed. In response to execution of the barrier instruction 132, the first thread 108 may identify the master thread 114 (e.g., based on the master thread identifier 138) and may provide a first message 142 to the master thread 114. As a non-limiting illustrative example, the processor 102 may include a buffer that is accessible to the first thread 108 and the master thread 114, and the processor 102 may store the first message 142 at the buffer during execution of the first thread 108 to enable access to the first message 142 during execution of the master thread 114. In an illustrative example, the processor 102 may execute a message passing instruction 134 to generate the first message 142.

The first message 142 may indicate that the first thread 108 is ready to perform a synchronization operation to synchronize with one or more other threads, such as other threads of the subset 140 that are associated with the synchronization operation. The first message 142 may include the master thread identifier 138 and an object identifier 144 that indicates one or more targets (or objects) to be synchronized in connection with the synchronization operation. In some implementations, the first message 142 includes an indication of a source of the first message 142 (i.e., the first thread 108). In other implementations, the first message 142 does not include an indication of a source of the first message 142.

The master thread 114 may receive or detect the first message 142. For example, during execution, the master thread 114 may access a buffer that stores the first message 142, as an illustrative example. In response to detecting the first message 142, the master thread 114 may determine whether a number of messages 116 associated with the synchronization operation satisfies a threshold 118. Depending on the particular implementation, the number of messages 116 may satisfy the threshold 118 if the number of messages 116 is greater than the threshold 118, is greater than or equal to the threshold 118, is less than the threshold 118, or is less than or equal to the threshold 118.

The threshold 118 is based on a number of threads of the subset 140. As an example, if the subset 140 includes two threads (e.g., the first thread 108 and the second thread 110), then the threshold 118 may be equal to two. As another example, if the subset 140 includes three threads (e.g., the first thread 108, the second thread 110, and the master thread 114), then the threshold 118 may be equal to three. The threshold 118 may correspond to the number of threads (or cardinality) of the subset 140 determined during the initialization operation.

If the number of messages 116 fails to satisfy the threshold 118, the master thread 114 may refrain from initiating the synchronization operation. For example, the master thread 114 may refrain from initiating the synchronization operation until each thread of the subset 140 is ready to perform synchronization of one or more targets (or objects) associated with the synchronization operation.

To further illustrate, in a particular example, the processor 102 executes the barrier instruction 130 of the second thread 110 after the master thread 114 detects the first message 142. In response to execution of the barrier instruction 130, the second thread 110 may provide a second message 146 to the master thread 114. As a non-limiting illustrative example, the processor 102 may include a buffer that is accessible to the second thread 110 and the master thread 114, and the processor 102 may store the second message 146 at the buffer during execution of the second thread 110 to enable access to the second message 146 during execution of the master thread 114.

The second message 146 may indicate that the second thread 110 is ready to perform a synchronization operation to synchronize with one or more other threads, such as other threads of the subset 140. The second message 146 may include the master thread identifier 138 and an object identifier 148 that indicates one or more targets to be synchronized in connection with the synchronization operation. In some implementations, the second message 146 includes an indication of a source of the second message 146 (i.e., the second thread 110). In other implementations, the second message 146 does not include an indication of a source of the second message 146.

The master thread 114 may receive or detect the second message 146, such as by accessing a buffer that stores the second message 146, as an illustrative example. In response to detecting the second message 146, the master thread 114 may determine whether the number of messages 116 associated with the synchronization operation satisfies the threshold 118. If the subset 140 includes two threads (e.g., the threads 108, 110), then the master thread 114 may determine that the number of messages 116 satisfies the threshold 118 upon receiving the messages 142, 146.

The master thread 114 may monitor the number of messages 116 using one or more techniques, such as an active technique, a passive technique, or another technique. In an illustrative example of an active technique, the master thread 114 may monitor the number of messages 116 using a register that stores a value corresponding to the number of messages 116. For example, the master thread 114 may increment (or decrement) the register from a first value to a second value in response to receiving the first message 142, and the master thread 114 may increment (or decrement) the register from the second value to a third value in response to receiving the second message 146. In response to receiving each message (e.g., the messages 142, 146), the master thread 114 may access the value of the register to determine the number of messages 116 and may compare the number of messages 116 to determine whether the number of messages 116 satisfies the threshold 118. In an illustrative example, the master thread 114 may execute a particular instruction (e.g., a “loop” instruction, an “if” instruction, or a “while” instruction) that causes the master thread 114 to refrain from initiating a synchronization operation while the number of messages 116 fails to satisfy the threshold 118.

In an illustrative example of a passive technique, the processor 102 may include a detection circuit, a counter (e.g., a write decrement counter), or both. The processor 102 may be configured to provide the detection circuit an indication of the number of threads (or cardinality) of the subset 140, which may correspond to the threshold 118. The detection circuit may be configured to count the number of messages 116 and to notify (e.g., wake) the master thread 114 in response to the number of messages 116 satisfying the threshold 118. For example, the detection circuit may adjust a value of the write decrement counter in response to receiving messages, such as the messages 142, 146. The value may indicate whether the number of messages 116 satisfies the threshold 118, and the detection circuit may provide a signal to the master thread 114 indicating that the number of messages 116 satisfies the threshold 118.

In some examples, one or more threads of the electronic device 100 may operate based on a sleep mode of operation. For example, the master thread 114 may initiate a sleep mode of operation in response to the number of messages 116 failing to satisfy the threshold 118. In some implementations, the master thread 114 may operate based on the sleep mode in connection with a passive technique. For example, the master thread 114 may notify detection circuitry of the processor 102 that the master thread 114 intends to initiate the sleep mode of operation and to notify the master thread 114 upon determining that the number of messages 116 satisfies the threshold 118. The master thread 114 may initiate an active mode of operation in response to the number of messages 116 satisfying the threshold 118 (e.g., in response to a signal from the detection circuitry indicating that the number of messages 116 satisfies the threshold 118).

In response to detecting that the number of messages 116 satisfies the threshold 118, the master thread 114 may initiate a synchronization operation associated with a target indicated by the object identifiers 144, 148. Initiating the synchronization operation may include initiating an event. For example, the master thread 114 may access the event circuitry 120, such as by setting the flag 122. The master thread 114 may adjust the flag 122 from a first value (e.g., one of a logic “0” value or a logic “1” value) to a second value (e.g., the other of the logic “0” value or the logic “1” value). The first value may indicate that a hold status of the synchronization operation (e.g., that the synchronization operation has not been initiated), and the second value may indicate a ready status associated with the synchronization operation (e.g., that the synchronization operation is ready to be performed). In some implementations, the master thread 114 is configured to restrict access to the event circuitry 120, such as by locking a register included in the event circuitry 120 to prevent a thread from changing the flag 122.

One or more threads of the electronic device 100 may detect that the flag 122 indicates that the synchronization operation is ready to be performed. To illustrate, threads of the subset 140 may monitor the event circuitry 120 to detect the second value of the flag 122. In an illustrative example, the processor 102 may execute an event handling instruction 136 to access the event circuitry 120 to detect the second value of the flag 122.

In response to detecting the second value of the flag 122, threads of the subset 140 may perform a synchronization operation. For example, threads of the subset 140 may synchronize data, such as by exchanging results of one or more operations. Alternatively or in addition, the synchronization operation may include synchronizing processes by threads of the subset 140. For example, the barrier instructions 130, 132 may correspond to particular point (e.g., a “meet up” point) in a joint process performed by the threads 108, 110 at which the threads 108, 110 synchronize (or “synch up”).

Although certain examples have been described with reference to the subset 140, it should be appreciated that aspects of FIG. 1 are applicable to other cases. For example, in certain cases, each thread of the electronic device 100 may participate in a synchronization operation. Further, although certain aspects of the first thread 108 have been described, it should be appreciated that such aspects may be applicable to one or more other threads, such as one or more of the second thread 110, the third thread 112, and the master thread 114 (alternatively or in addition to the first thread 108). In addition, although examples of FIG. 1 are described with reference to the processor 102, it is noted that a synchronization operation may be performed “across” processors (e.g., where one or more threads of the processors 104, 106 participate in the synchronization operation).

One or more aspects of FIG. 1 may improve performance of a device. For example, the initialization operation described with reference to FIG. 1 may enable selection of particular threads of the electronic device 100 that are to participate in a synchronization operation associated with a particular target (or object). Selection of particular threads using the initialization operation may improve device performance as compared to certain conventional techniques that perform “global” thread synchronization. For example, selection of particular threads using the initialization operation may increase processing throughput by reducing or eliminating halting of execution of threads that are not scheduled to synchronize based on the particular object.

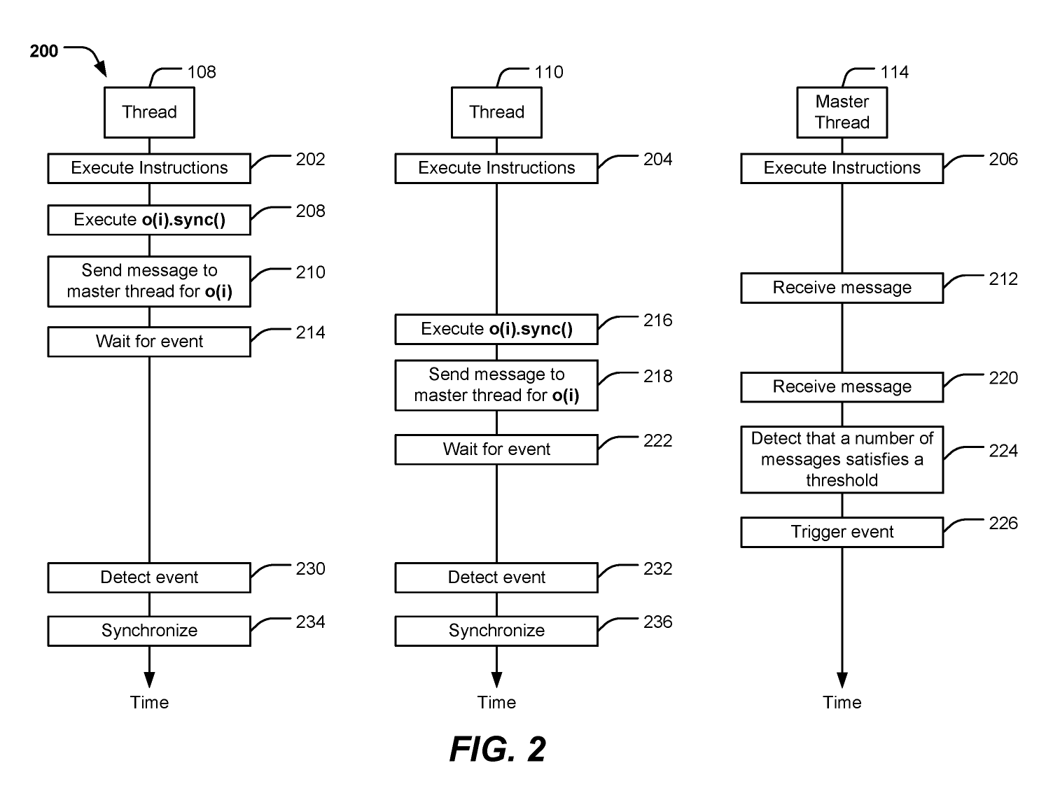

FIG. 2 illustrates an example of a synchronization operation 200. The synchronization operation 200 may be performed by the electronic device 100 of FIG. 1. The synchronization operation 200 may be performed after the initialization operation described with reference to FIG. 1. The synchronization operation 200 may correspond to the synchronization operation described with reference to FIG. 1.

The synchronization operation 200 may be performed using a set of threads of the electronic device 100 of FIG. 1 or using a subset of threads of the electronic device 100 of FIG. 1, such as the subset 140. In the example illustrated in FIG. 2, the synchronization operation may be performed using the threads 108, 110, and 114. In this example, the subset 140 of FIG. 1 includes the threads 108, 110, and 114.

The synchronization operation 200 may include executing instructions by the first thread 108, at 202. The synchronization operation 200 may also include executing instructions by the second thread 110, at 204, and executing instructions by the master thread 114, at 206.

The first thread 108 may execute a barrier instruction associated with an object, at 208. In the example of FIG. 2, the object is indicated by o(i), and the barrier instruction associated with the object is indicated by o(i).sync( ) In FIG. 2, i may refer to an index value of the object (e.g., to distinguish the object from one or more other objects in a set of objects associated with the synchronization operation 200). In an illustrative example, the barrier instruction executed by the first thread 108 corresponds to the barrier instruction 132 of FIG. 1.

In response to executing the barrier instruction, the first thread 108 may send a message to the master thread 114, at 210. The message may indicate the object o(i). To illustrate, the message may correspond to the first message 142 of FIG. 1, and the object identifier 144 may indicate the object o(i). The master thread 114 may receive the message from the first thread 108, at 212.

Upon sending the message to the master thread 114, the first thread 108 may enter a wait mode of operation, at 214. In some implementations, the first thread 108 may enter a sleep mode of operation during the wait mode. In some implementations, the first thread 108 may query the event circuitry 120 during operation according to the wait mode.

The second thread 110 may execute a barrier instruction associated with the object, at 216. In an illustrative example, the barrier instruction executed by the second thread 110 corresponds to the barrier instruction 130 of FIG. 1.

In response to executing the barrier instruction, the second thread 110 may send a message to the master thread 114, at 218. The message may indicate the object o(i). To illustrate, the message may correspond to the second message 146 of FIG. 1, and the object identifier 148 may indicate the object o(i). The master thread 114 may receive the message from the second thread 110, at 220.

Upon sending the message to the master thread 114, the second thread 110 may enter a wait mode of operation, at 222. In some implementations, the second thread 110 may enter a sleep mode of operation during the wait mode. In some implementations, the second thread 110 may query the event circuitry 120 during operation according to the wait mode.

The master thread 114 may detect that a number of messages satisfies a threshold, at 224 (e.g., indicating that all threads associated with the object o(i) have executed the barrier instruction). The number of messages may correspond to the number of messages 116 of FIG. 1, and the threshold may correspond to the threshold 118 of FIG. 1.

The master thread 114 may trigger an event, at 226. Triggering the event may include setting the flag 122 of FIG. 1 to indicate a ready status of the synchronization operation 200.

The first thread 108 may detect the event, at 230, and the second thread 110 may detect the event, at 232. For example, the first thread 108 and the second thread 110 may query a register of the event circuitry 120 to detect that the flag 122 indicates a ready status of the synchronization operation 200.

The first thread 108 and the second thread 110 may synchronize, at 234 and at 236. For example, to synchronize data, the first thread 108 may send data to the second thread 110, and the second thread 110 may send data to the first thread 108. Alternatively or in addition, to synchronize a process, the first thread 108 may send a state indication to the second thread 110, and the second thread 110 may send a state indication to the first thread 108. Alternatively or in addition, synchronization may include one or more other operations.

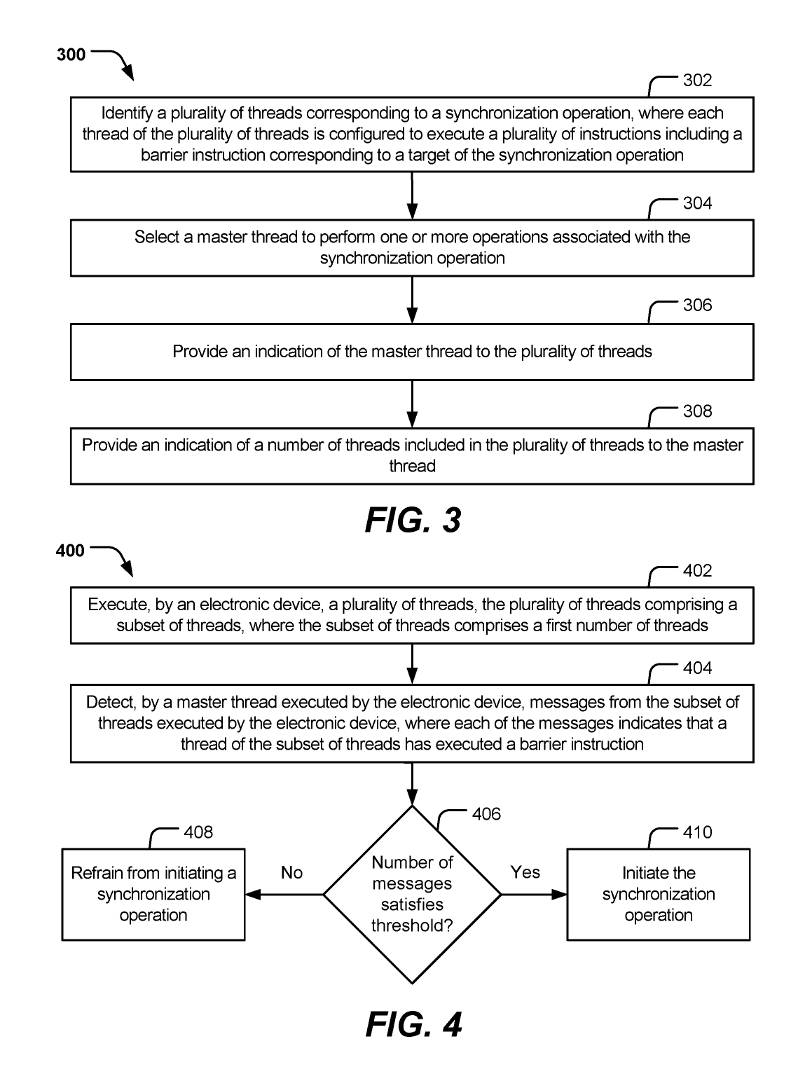

FIG. 3 depicts an illustrative example of a method 300 of operation of an electronic device. In a particular example, the method 300 may be performed by the electronic device 100 of FIG. 1. The method 300 may correspond to the initialization operation described with reference to FIG. 1.

The method 300 includes identifying a plurality of threads corresponding to a synchronization operation, at 302. Each thread of the plurality of threads is configured to execute a plurality of instructions including a barrier instruction (e.g., the barrier instruction 132) corresponding to a target (e.g., the object o(i)) of the synchronization operation. In an illustrative example, the plurality of threads corresponds to a subset of threads of the electronic device 100, such as the subset 140. In another example, the plurality of threads may include each thread of the electronic device 100.

The method 300 further includes selecting a master thread to perform one or more operations associated with the synchronization operation, at 304. For example, the processor 102 may select the master thread 114. In some implementations, the processor 102 selects the thread 114 as the master thread based on the thread 114 having a lowest thread identifier of threads associated with the synchronization operation.

The method 300 may further include providing an indication of the master thread to the plurality of threads, at 306. For example, the indication may correspond to the master thread identifier 138.

The method 300 further includes providing an indication of a number of threads included in the plurality of threads to the master thread, at 308. For example, the indication may correspond to the threshold 118.

FIG. 4 depicts an illustrative example of a method 400 of operation of an electronic device. In a particular example, the method 400 may be performed by the electronic device 100 of FIG. 1. The method 400 may correspond to the synchronization operation described with reference to FIG. 1, the synchronization operation 200 of FIG. 2, or both.

The method 400 includes executing, by an electronic device, a plurality of threads, at 402. The plurality of threads include a subset of threads, and the subset of threads comprises a first number of threads. To illustrate, the plurality of threads may include the threads 108, 110, 112, and 114, the subset of threads may include the subset 140, and the first number may correspond to N.

The method 400 further includes detecting, by a master thread executed by the electronic device, messages from the subset of threads executed by the electronic device, at 404. Each of the messages indicates that a thread of the subset of threads has executed a barrier instruction. For example, the first message 142 may indicate that the first thread 108 has executed the barrier instruction 132. As another example, the second message 146 may indicate that the second thread 110 has executed the barrier instruction 130.

The method 400 further includes determining whether a number of the messages satisfies a threshold that is based on the first number, at 406. In an illustrative example, the master thread 114 may monitor the number of messages 116 to determine whether the number of messages 116 satisfies the threshold 118. In another illustrative example, a detection circuit may monitor the number of messages 116 to determine whether the number of messages 116 satisfies the threshold 118.

The method 400 further includes refraining from initiating a synchronization operation in response to the number of the messages failing to satisfy the threshold, at 408. As an illustrative example, if the subset 140 includes N threads, the master thread 114 may refrain from initiating the synchronization operation if (and while) the number of messages 116 is less than N.

The method 400 further includes initiating the synchronization operation in response to the number of the messages satisfying the threshold, at 410. As an illustrative example, if the subset 140 includes N threads, the master thread 114 may initiate the synchronization operation if the number of messages 116 corresponds to N. Initiating the synchronization operation may include setting the flag 122, such as by adjusting a value of the flag 122 from a first value indicating a hold status of the synchronization operation to a second value indicating a ready status of the synchronization operation, as an illustrative example.

One or more hardware components may be used to perform one or more operations of the method 300 of FIG. 3, one or more operations of the method 400 of FIG. 4, one or more other operations described herein, or a combination thereof. As a non-limiting illustrative example, the processor 102 may include a comparator circuit configured to compare the number of messages 116 to the threshold 118 to determine whether the number of messages 116 satisfies the threshold 118.

Alternatively or in addition, instructions may be executed to perform one or more operations of the method 300 of FIG. 3, one or more operations of the method 400 of FIG. 4, one or more other operations described herein, or a combination thereof. As a non-limiting illustrative example, the processor 102 may execute a compare instruction to compare the number of messages 116 to the threshold 118 to determine whether the number of messages 116 satisfies the threshold 118. Alternatively or in addition, instructions may be retrieved from a memory (e.g., a non-transitory computer readable medium) and executed (e.g., using the ALU 124 or an FPU) to perform one or more operations of the method 300 of FIG. 3, one or more operations of the method 400 of FIG. 4, one or more other operations described herein, or a combination thereof.

In some cases, one or more operations described herein may be performed using an one or more instructions of instruction set architecture (ISA). For example, one or more of the barrier instruction 132, the message passing instruction 134, and the event handling instruction 136 may correspond to primitives (e.g., machine instructions) of the ISA. In an illustrative example, the ISA specifies that the event handling instruction 136 enables a thread to sleep until detection of an event associated with the event handling instruction 136 (e.g., until detecting that the flag 122 is set). The ISA may specify that an argument of the message passing instruction 134 may be provided to a master thread, such as the master thread 114.

In some examples, the electronic device 100 includes multiple graphics processing units (GPUs), and a synchronization operation is performed for a subset of (i.e., fewer than all of) the multiple GPUs. Alternatively or in addition, a synchronization operation may be performed for multiple GPUs if multiple GPUs execute threads that are to synchronize an object of a synchronization process. In some implementations, a GPU may have a single instruction, multiple data (SIMD) configuration.

Although certain examples are described with reference to a single master thread (e.g., the master thread 114 of FIG. 1), in some implementations, a hierarchical technique may include using one or more sub-master threads to communicate with a master thread. As an illustrative example, the master thread 114 may function as a sub-master thread that communicates with another thread, such as the third thread 112. In this example, the master thread 114 may provide an indication to the third thread 112 in response to detecting that the subset 140 is ready to synchronize (e.g., in response to the number of messages 116 satisfying the threshold 118). Another sub-master thread of the electronic device 100 may provide an indication to the third thread when another subset of threads of the electronic device 100 is ready to synchronize. For example, a master thread of the processor 104 may provide an indication to the third thread 112 in response to detecting that one or more threads of the processor 104 are ready to synchronize with threads of the subset 140. As another example, a master thread of the processor 106 may provide an indication to the third thread 112 in response to detecting that one or more threads of the processor 106 are ready to synchronize with threads of the subset 140. In some cases, use of a hierarchical technique may reduce workload of a master thread by distributing or assigning operations to multiple sub-master threads (e.g., instead of assigning operations to a single thread, such as the master thread 114).

One or more aspects described herein may be applied to a variety of applications. To illustrate, in an example of a neural network application, threads of the electronic device 100 may perform a set of operations that are distributed among processors of the electronic device 100 based on a neural network model. The neural network model may specify one or more nodes that connect neurons of the neural network model, such as a node that indicates a set of operations are to “join up” using a synchronization operation described herein.

A device or component described herein may be represented using data. As an example, an electronic design program may specify a group of components to enable a user to design an integrated circuit that includes one or more components described herein. Data representing such components may be provided to a circuit designer to design a circuit, to a physical layout creator that designs a physical layout for the circuit, to a semiconductor foundry (or “fab”) that fabricates integrated circuits based on the physical layout, to a testing entity that tests the integrated circuits, to a packaging entity that incorporates the integrated circuits into packages, to an assembly entity that assembles packaged integrated circuits onto printed circuit boards (e.g., onto motherboards), to an assembly entity that assembles printed circuit boards and/or other components into electronic devices (e.g., the electronic device 100 of FIG. 1), to one or more other entities, or a combination thereof. Examples of electronic devices (e.g., the electronic device 100) include computers (e.g., servers, desktop computers, laptop computers, and tablet computers), phones (e.g., cellular phones and landline phones), network devices (e.g., base stations and access points), communication devices (e.g., modems, routers, and switches), and vehicle control systems (e.g., an electronic control unit (ECU) of a vehicle or an autonomous vehicle, such as a drone or a self-driving car), and healthcare devices, as illustrative examples.

The abstract and the summary are provided for convenience and not intended to limit the scope of the claims. Further, the examples described above with reference to FIGS. 1-4 are provided for illustration and are not intended to be limiting. Those of skill in the art will appreciate that modifications to the examples may be made without departing from the scope of the disclosure.

What is claimed is:

1. A method of operation of an electronic device, the method comprising:
identifying a plurality of threads corresponding to a synchronization operation, wherein each thread of the plurality of threads is configured to execute a plurality of instructions including a barrier instruction corresponding to a target of the synchronization operation;
selecting a master thread to perform one or more operations associated with the synchronization operation; and
providing an indication of a number of threads included in the plurality of threads to the master thread.

2. The method of claim 1, further comprising providing an indication of the master thread to each thread of the plurality of threads.

3. The method of claim 1, wherein identifying the plurality of threads, selecting the master thread, and providing the indication of the number of threads are performed during an initialization operation at the electronic device.

4. The method of claim 1, further comprising:
providing a first message to the master thread, the first message indicating that a first thread of the plurality of threads has executed the barrier instruction;
determining whether a number of messages satisfies a threshold; and
in response to the number of messages failing to satisfying the threshold, refraining from initiating the synchronization operation.

5. The method of claim 4, further comprising:
providing a second message to the master thread, the second message indicating that a second thread of the plurality of threads has executed the barrier instruction;
after receiving the second message, determining whether the number of messages satisfies the threshold; and
in response to the number of messages satisfying the threshold, initiating the synchronization operation.

6. The method of claim 5, wherein initiating the synchronization operation includes setting a flag in a register of the electronic device.

7. A method of operation of an electronic device, the method comprising:
executing, by the electronic device, a plurality of threads, the plurality of threads comprising a subset of threads, wherein the subset of threads comprises a first number of threads;
detecting, by a master thread executed by the electronic device, messages from the subset of threads executed by the electronic device, wherein each of the messages indicates that a thread of the subset of threads has executed a barrier instruction; and
initiating a synchronization operation in response to a number of the messages satisfying a threshold that is based on the first number.

8. The method of claim 7, wherein each of the messages includes an object identifier associated with a target of the synchronization operation.

9. The method of claim 7, further comprising selecting a particular thread executed by the electronic device as the master thread during an initialization operation performed by the electronic device.

10. The method of claim 9, wherein the particular thread is selected as the master thread based on a thread identifier associated with the particular thread.

11. The method of claim 10, further comprising:
identifying the subset of threads based on the subset of threads including the barrier instruction; and
providing the subset of threads an indication of the thread identifier during the initialization operation to enable the subset of threads to send the messages to the master thread.

12. The method of claim 7, further comprising initiating a sleep mode of operation by the master thread in response to the number of the messages failing to satisfy a threshold.

13. The method of claim 7, further comprising initiating an active mode of operation by the master thread in response to the number of the messages satisfying the threshold.

14. The method of claim 7, wherein the subset of threads includes the master thread.

15. The method of claim 7, wherein the subset of threads excludes the master thread.

16. The method of claim 7, further comprising, in response to the number of the messages satisfying the threshold, setting a flag associated with the synchronization operation to a ready status.

17. An apparatus comprising:
circuitry configured to store a flag associated with a synchronization operation, wherein a first value of the flag indicates a hold status associated with a synchronization operation among a subset of threads executed by one or more processors, and wherein a first number of threads of the subset is less than a second number of threads executed by the one or more processors; and
a processor configured to detect messages from the subset of threads and to set the flag to a second value in response to a number of the messages satisfying a threshold, the second value indicating a ready status of the synchronization operation.

18. The apparatus of claim 17, wherein the circuitry includes a register configured to store the flag.

19. The apparatus of claim 17, further comprising:
a memory configured to store initialization instructions; and
one or more processing units configured to execute the initialization instructions to identify the subset of threads and to select a master thread.

20. The apparatus of claim 17, wherein a first thread of the subset of threads includes a barrier instruction executable by the processor to send a first message of the messages.
